(19) United States
(12) Patent Application Publication
(10) Pub. No.: US 2011/0273093 A1
(43) Pub. Date: Nov. 10, 2011

(54) ENCAPSULATED COMPACT FLUORESCENT BULBS AND ARTICLES AND METHODS OF MANUFACTURE

(76) Inventor: Gregory Caldwell, Stow, OH (US)

(21) Appl. No.: 13/102,738

(22) Filed: May 6, 2011

Related U.S. Application Data
(60) Provisional application No. 61/332,510, filed on May 7, 2010.

(51) Int. Cl. H01J 61/56; H01J 9/20; H01J 61/35

(52) U.S. Cl. 315/56; 445/58

(57) ABSTRACT

There is described a compact fluorescent lamp and articles that are coated with a shatterproof silicone overmold. The coated compact fluorescent lamp provides safety and containment and peace of mind to the general public while eliminating worries of broken glass and mercury exposure. The coated bulb provides shock resistance to prevent breakage in many typical drops, or total glass containment with the silicone overmold if the bulb does break. The shatterproof silicone coated compact fluorescent lamp with containment system will prevent the bulb from shattering or exploding if dropped. The silicone overmold is adhered directly to the glass gas filled tube and base allowing for containment of mercury and as a catalyst for recycling. Methods of manufacturing silicone coated compact fluorescent lamps by dipping a bulb in a solvent dispersion of uncured silicone rubber to provide one or more layers is also provided.

### INCORPORATION BY REFERENCE/RELATED APPLICATIONS

This patent application claims the benefit of and priority to U.S. Provisional Patent Application Ser. No. 61/332,510 filed on May 7, 2010, the disclosure of which is expressly incorporated by reference herein in its entirety.

### TECHNICAL FIELD

The invention generally contemplates providing new and improved containment system for compact fluorescent lamps (CFL's). This containment system will provide containment and/or neutralization of mercury, phosphorous and glass that is exposed when breakage occurs and processes of manufacturing silicone encapsulated compact fluorescent bulbs and articles made from solvent dispersions which forms a structural coating on the compact fluorescent lamp.

### BACKGROUND

Developed in the 1970's the compact fluorescent lamp (CFL) has gained popularity over the years and especially in recent years with energy conservation becoming a global necessity. Units manufactured worldwide are currently close to 4 billion annually and production continues to increase exponentially combined with a global initiative to phase out the traditional incandescent bulb. The CFL bulb utilizes mercury in its components to create energy savings, but when the bulbs break mercury exposure and contamination create health and safety hazards.

CFL sales have been increasing due to government action. For example, in 2007, Australia became the first country to ban the sale of incandescent bulbs, and sales there will be phased out entirely by 2009. The European Union, Ireland, and Canada have since announced plans to ban incandescent bulbs. The United States has also passed legislation increasing the efficiency standard required for light bulbs, which will effectively phase out incandescent bulbs. In total, more than 40 countries have announced plans to follow suit. CFL bulbs are lighting more homes than ever before, and the Environmental Protection Agency (EPA) is encouraging Americans to use and recycle CFL bulbs safely. Carefully recycling CFL bulbs prevents the release of mercury into the environment and allows for the reuse of glass, metals and other materials that make up fluorescent lamps. The EPA is continually reviewing its clean-up and disposal recommendations for CFLs to ensure that the Agency presents the most up-to-date information for consumers and businesses. Maine's Department of Environmental Protection released a CFL breakage study report on Feb. 25, 2008. The EPA has conducted an initial review of this study and, as a result of this review, it has updated its CFL cleanup instructions.

Pending the completion of a full review of the Maine study, the EPA will determine whether additional changes to the cleanup recommendations are warranted. The agency plans to conduct its own study on CFLs after thorough review of the Maine study.

In the Maine study, experimental trials where compact fluorescent lamps (CFLs) were broken in a small/moderate sized room were conducted. Broken lamps were either not cleaned up, cleaned up using Maine Department of Environmental Protection (DEP) pre-study cleanup guidance, vacuumed, or cleaned up using variations of the pre-study cleanup guidance. The mercury concentrations at the five foot height (adult breathing zone) and one foot height (infant/toddler breathing zone) above the study room floor were continuously monitored. A notable finding of the study was how variable the results can be depending on the type of lamp, level of ventilation and cleanup method.

The pre-study cleanup guidance was generally found to be sound, including the advice to not vacuum as part of the cleanup. However as a result of this study, the cleanup guidance was modified.

Mercury concentration in the study room air often exceeds the Maine Ambient Air Guideline (MAAG) of 300 nanograms per cubic meter (ng/m³) for some period of time, with short excursions over 25,000 ng/m³, sometimes over 50,000 ng/m³, and possibly over 100,000 ng/m³ from the breakage of a single compact fluorescent lamp. A short period of venting can, in most cases, significantly reduce the mercury air concentrations after breakage. Concentrations can sometimes rebound when rooms are no longer vented, particularly with certain types of lamps and during/after vacuuming. Mercury readings at the one foot height tend to be greater than at the five foot height in non vacuumed situations.

Although following the pre-study cleanup guidance produces visibly clean flooring surfaces for both wood and carpets (shag and short nap), all types of flooring surfaces tested can retain mercury sources even when visibly clean. Flooring surfaces, once visibly clean, can emit mercury immediately at the source that can be greater than 50,000 ng/m³. Flooring surfaces that still contain mercury sources emit more mercury when agitated than when not agitated. This mercury source in the carpeting has particular significance for children rolling around on a floor, babies crawling, or non mobile infants placed on the floor.

Cleaning up a broken CFL by vacuuming up the smaller debris particles in an un-vented room can elevate mercury concentrations over the MAAG in the room and it can linger at these levels for hours. Vacuuming tends to mix the air within the room such that the one foot and five foot heights are similar immediately after vacuuming. A vacuum can become contaminated by mercury such that it cannot be easily decontaminated. Vacuuming a carpet where a lamp has broken and been visibly cleaned up, even weeks after the cleanup, can elevate the mercury readings over the MAAG in an un-vented room.

In the coming years with energy conservation being a global initiative, the sales of CFL bulbs and possible exposure to mercury becomes an ever-growing safety concern. With mercury exposure and possible poisoning there is a need for mercury containment and/or neutralization and glass containment to alleviate these issues in association with CFLs. The containment will also allow for more effective recycling.

### SUMMARY

This invention described herein is thus directed to coated compact fluorescent lamp (CFL) bulbs or other like articles. The encapsulated CFL bulb will provide peace of mind and safety by preventing exposure to harmful mercury, phosphorus and glass released when CFL bulbs break. The encapsulation prevents shattering or exploding if or when dropped. The encapsulation on the bulb also provides shock resistance to prevent breakage in many typical drops or total containment with the silicone encapsulation if the bulb does break. The shatterproof silicone encapsulated CFL bulb and containment system is ideal for consumers and business including but not limited to hotels, schools, offices and public and private institutions, who have limited knowledge of the recommended cleanup procedure if a CFL bulb breaks.

The use of curable elastomeric silicone compositions for coating and encapsulating CFL bulbs or articles of the like according to the invention provides for increased tensile strength in the encapsulated article. In examples, the encapsulation maybe clear with minimal color, lumen or Kelvin scale value changes or may employ a large spectrum of colors to change the color, lumens or Kelvin scale value of the bulb. The coating is stable at higher temperatures and will not yellow, crack or peel. The silicone has a long shelf life without degradation, and bonds to the CFL bulb envelope. The silicone may be applied and cured at relatively cool temperatures, and the coating is formed so as to be free of encapsulated bubbles during manufacturing.

There are also provided methods of producing the encapsulated CFL bulbs by a dipping process. The method provides for use of an apparatus for encapsulating one or more CFL bulbs with a protective material by dipping the CFL bulb into the protective material in a dip tank. A fixture for holding a plurality of CFL bulbs is provided and used in association with a computer controlled two or three axis automatic dipping unit. The dipping system may allow different dipping recipes to be developed for different glass articles, and for precise encapsulating steps to be employed and operated by the computer. The system may have one or more extended mounting arms for receiving multiple holding fixtures for mounting the CFL bulbs for dipping. A separate dip tank may be used which includes automatic temperature, viscosity, level and mixing controls to provide a dipping solution having the desired characteristics which is uniform over multiple dipping cycles. A dip tank shuttle may be used to allow multiple dipping cycles to be performed quickly using multiple mounting arms. The dipping system may be contained in an enclosure to allow control of and evacuation and treatment of evaporated solvents. A programmable laminar flow drying system may be provided in association with the dipping system to facilitate higher production capabilities.

There is also provided a article and methods for providing neutralization or sequestration of mercury in the event of bulb breakage. A mercury neutralizing material is provided as a separate coating of the bulb, or such materials may be integrated into the coating for the fluorescent lamp.

The coated compact fluorescent lamp provides the benefits of shatter resistance and full containment of the glass, mercury and phosphorus if the bulb does break. The coated glass bulb provides peace of mind that a consumer seeks when being conscious of safety and mercury exposure and prevents the bulb from “exploding” and releasing mercury and phosphorus if or when dropped or broken. The shatterproof silicone coated compact fluorescent bulb and containment system is ideal for consumers who will accept nothing but the safest products for their home and businesses.

These and other aspects of the present invention will be apparent to one skilled in the art from the following description.

### BRIEF DESCRIPTION OF THE DRAWINGS

FIG. 1 is a side elevation of the spiral compact fluorescent bulb showing encapsulation according to an example of the invention.

FIG. 1A is a cross sectional view of the spiral compact fluorescent bulb of FIG. 1 with a coating provided and key strength points revealed to show an example of the invention.

FIG. 2 is a flow chart of a method according to an example of the invention.

FIG. 3 is a side elevation showing a dipping system for a plurality of CFL bulbs.

FIG. 4 is a side elevation of the encapsulated tube compact fluorescent bulb.

FIG. 4A is a cross sectional view of the tube compact fluorescent bulb with a coating provided and key strength points revealed to show an example of the invention.

FIG. 5 is a cross sectional view of a further embodiment of the compact fluorescent bulb.

FIG. 6 is a cross sectional view of a compact fluorescent bulb according to an example of the invention.

FIG. 7 is a cross sectional view of the compact fluorescent bulb of FIG. 5.

### DETAILED DESCRIPTION OF THE DRAWINGS

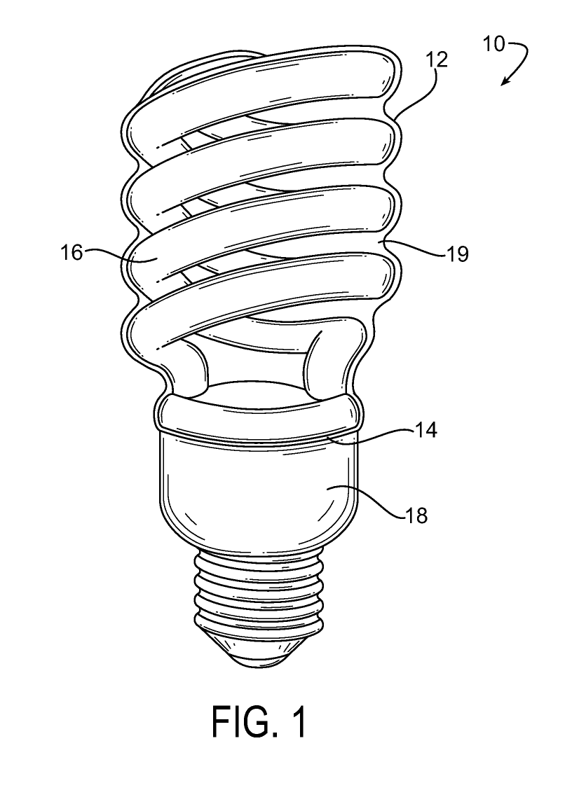

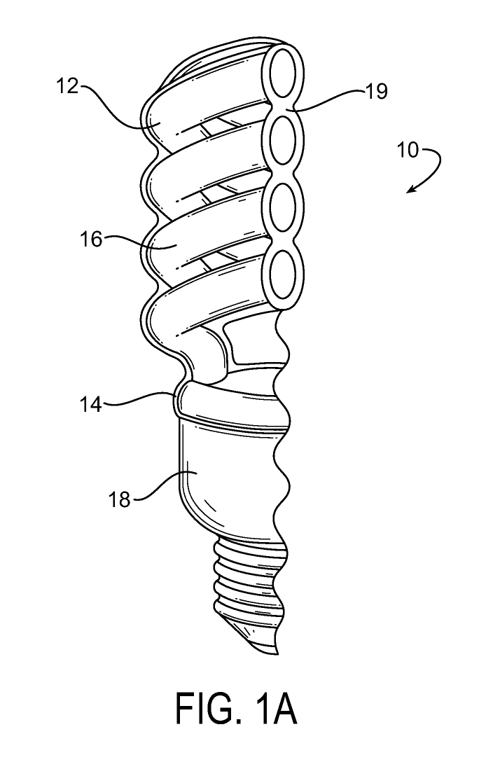

With reference now to the drawings, and in particular to FIG. 1, a compact fluorescent lamp 10 coated with a shatterproof silicone overmold 12 is shown. The bulb 10 has a gas filled tube 16 connected to the magnetic or electronic ballast contained in the plastic base 18. The coating 12 extends onto the plastic base 18 to an extent at 14. The coating 12 on the bulb 10 may be thick enough to provide shock resistance to prevent breakage of the glass tube 16 in many typical drops, such as from a ladder, table, shelf or the like. For example, the thickness may be between 0.10 mm to 6.35 mm. In one embodiment, the thickness is between 0.3 mm to 2.5 mm for example, or for many CFL configurations, between about 0.5 to 1.5 mm. However, other thicknesses may be suitable depending on the application or desired characteristics of the final product. In some environments, it may be desired to have a thicker coating to provide enhanced protection against breakage or enhanced containment. It may also be desired to have a varying thickness coating on the bulb 10, for example with a thicker coating at the top or outer portions of the bulb 10, that are more likely to have impact forces exerted on them. The coating 12 provides shock resistance due to the nature of the coating itself, as well as the manner in which it contains the glass tube sections of the bulb 10. As seen in FIGS. 1 and 1A, in an example embodiment, the bulb 10 is overmolded in such a fashion that the once independent or separated glass tubes 16 are now connected to each other via connecting sections or webs 19 of the coating 12. These connecting sections 19 provide greatly increased structural strength of the bulb 10 and to each independent tube section 16, to greatly increase the tensile strength of the bulb 10 and therefore reducing the risk of breakage. The connecting portions 19 also allow for added performance and provide full containment, with the entire coating 12, of any broken glass, phosphorus, mercury or other materials. The connecting portions 19 also provide a reduced risk of breakage during installation and removal by counteracting a rotational force applied. This invention is especially beneficial and important for the consumer who does not understand that is not recommended to install compact fluorescent bulbs by holding the gas filled tube 16. In many common installation situations the fixture that the CFL bulb 10 is being installed into has insufficient room to install the bulb 10 correctly by holding the base 18 only, which are the manufacturers recommended installation practices due to the fragile glass tube 16. Thus, if the bulb 10 does break, the overmold 12 provides total glass and chemical containment within the silicone overmold, to prevent the mercury release or mess that would occur otherwise upon bulb breakage. The coating 12 U.S. Food and Drug Administration (FDA) compliant silicone materials to form the overmold 12, that are safe and durable. The silicone overmold 12 is adhered directly to the CFL envelope or glass tube 16 and base 18, to prevent breakage, contain mercury, phosphorus and glass and provide better gripping characteristics for installation and removal. The coating 12 may be transparent or translucent to minimize color, lumen or Kelvin scale changes to allow light to show through as if the coating were effectively not present, or the coating may employ a large spectrum of colors to change the color, lumens or Kelvin scale value of the bulb. As the coating 12 is directly adhered to the bulb 10, it will be used in a normal fashion with no extra care or precaution for the consumer. As for other compact fluorescent bulbs, the coating 12 may be easily applied to different size or shape compact fluorescent bulbs or articles.

In this example, the protective material of coating or overmold 12 is formed of a FDA food contact approved silicone material, such as Elastosil® products from Wacker Chemical Co. or Silastic® products from Dow Corning, but other suitable silicone materials may be used, or other suitable materials such as natural rubber. This material is crystal clear, non-toxic, and allows application via dipping and/or spraying for example. As mentioned previously, the coating 12 may have a desired and varying thickness, and such techniques may allow the desired coating thickness or varying thickness to be achieved. The material and thickness of the coating 12 is designed to resist tearing, such as if the bulb 10 does break, and thus to retain any glass, mercury and phosphorus (or other materials) therein. The coating 12 may have a durometer of 20 A to 80 A for example, with durometer adjustable for the application.

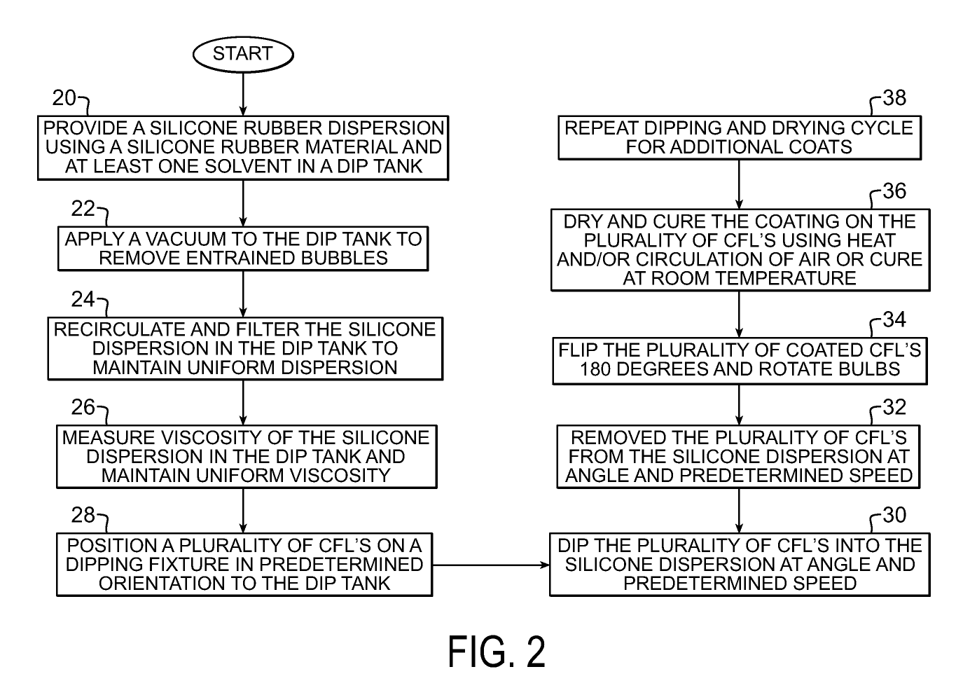

As seen in FIG. 2, a first process for forming the coating 12 on bulb 10 may be a dipping process which includes the steps of providing a liquid silicone dispersion using at least one solvent at 20 in a dip tank. The dispersion of base polymer in at least one solvent comprises about 30-65% by weight of base polymer. For example, the silicone rubber mixture may include multiple components, which in an example are Elastosil® A and Elastosil® B, in equal amounts of 25% each, along with at least one solvent to form a dispersion of silicone rubber. A cross-linking agent may be added to the dispersion at the time it is placed in the dipping tank. For example, the silicone rubbers which may be used to form the coating have as a base polymer an organopolysiloxane and may utilize either platinum, benzyl peroxide, dichlorobenzyl peroxide or other suitable vulcanization/curing systems. Fillers may also be used in the rubber composition to increase tensile strength and reinforcing silicone fillers which are inert to animal fluids and tissues when used as an integral part of the rubber formulation. Suitable silicone rubber base polymers are known to those skilled in the art.

Contemplated solvents include any suitable pure or mixture of organic, organo-metallic or inorganic molecules that are volatilized at a desired temperature. The solvent may also comprise any suitable polar and non-polar compounds. In an example, the solvent comprises about 40% heptane and 8-10% D-limonene, but other amounts of these solvents may be used. Other solvents such as, toluene, pentane, hexane, cyclohexane, benzene, xylene, halogenated solvents such as carbon tetrachloride, and mixtures thereof or others may be suitable.

A vacuum is applied at 22 to remove any entrained bubbles from the dip tank 52 by degassing. The silicone dispersion is maintained in a uniform mixture by vacuum pumping of the mixture in the tank through suitable filters, such as metal mesh filters, by a re-circulating pump at 24. Other methods such as stirring may also be used. The laminar flowability of the mixture is maintained during one or more dipping cycles. The viscosity of the mixture is measured and maintained at 26 by the addition of constituents as needed between dipping cycles. The viscosity of the dispersion may be in the range of 2500-7900 centipoises, or in a range of about 5000-5500 cp for example. The viscosity allows the desired thickness of the coating 12 to be obtained in one or more dipping cycles, and is set to allow any entrained bubbles to be effectively removed upon application of a vacuum or de-gassing step as described below.

A plurality of bulbs 10 are positioned on a dipping fixture at 28, and lowered into the dip tank at a predetermined angle relative to the dispersion and at a predetermined speed at 30. The angle is generally between 0-20° relative to the horizontal surface of the dispersion, depending on the shape of the bulb 16 for example. As some bulbs 10 may have portions that may entrain bubbles, the angled approach eliminates any formation of any bubbles around the base 18 or portions of the glass tube sections 16, and ensures uniform or varied coating thereof. If there is no portions of the bulb 10 that entrain or create bubbles due to its configuration, the angling of the bulb 10 into the dispersion may not be necessary. The speed at which the bulbs 10 are dipped is generally substantially uniform and between about 50 to 100 mm/second, for example. The substantially uniform speed of dipping into and from the dip tank provides a substantially uniform thickness coating 12 on the bulb 10. If a varying thickness is desired, the speed of dipping may be altered to obtain the desired coating thicknesses on the corresponding portions of the bulb 10 as may be desired. The bulbs 10 are dipped to the level of base 14 (see FIG. 1) and may be rotated such that the level of the silicone rubber dispersion covers the entire portion of the bulb 10 above the base 14. Alternately, the dipping fixture may be rotated such that the bulb 10 is perpendicular to the silicone dispersion at the level of the base 14 to fully coat the bulb 10 up to the base 14. The bulb 10 is maintained in the dispersion for a predetermined time, such as 5-10 seconds, to ensure even coating on the entire exterior surface of bulb 10, all the way to base 14, and to create the connecting portions 19. The bulbs 10 are then angled and removed from the silicone dispersion at a predetermined speed at 32 to provide an even coating over the entire outer surface of bulbs 10. Multiple dipping cycles may be employed to gain the desired coating thickness. The movement of the bulb 10 may be paused at the point that the bulb just exits the dispersion to allow any extra material to detach via the surface tension of the dispersion. Once removed from the dispersion, the coated bulbs 10 are flipped 180° at 34. The coated bulbs 10 may also be rotated after removal from the dispersion to substantially prevent movement of the coating by forces of gravity. The coating 12 on bulbs 10 is then dried at 36, such as by heating and/or air circulation, until solvents are evaporated and curing/polymerization of the coating is achieved. For example, an oven type arrangement may be used to facilitate curing of the silicone and evaporation of the solvent(s) therein.

The silicone dispersion in which the bulbs 10 are dipped is viscous and is circulated and filtered in order to keep it from setting prematurely. As the dispersion is subjected to constant circulation and has a predetermined viscosity, uniform coating to the desired level on the bulbs may be facilitated by control of the depth of the dispersion in the dip tank such as by providing a weir or dam over which the liquid dispersion flows to a re-circulation pump. Other methods of maintaining the desired depth of dispersion may be used, such as depth sensors monitoring the surface of the dispersion to obtain a precise distance from the surface of the material to a fixed predetermined point. The dipping fixture will normally have only one type of bulb 10 engaged with it, and the position of the fixture can be precisely controlled via computer control, to accurately position the bulbs 10 relative to the dispersion.

It is further envisioned that vibrational energy may be applied to the silicone dispersion in the dip tank 52 during a dipping cycle. The vibrational energy may be provided by either a sonic or mechanical means, which may be directed towards the dip tank 52 mixtures. The vibrational energy, including agitation and/or vibration, may ensure that the surface level of the silicone dispersion remains substantially uniform, and may provide for less surface tension and viscosity by movement of the molecules, thereby preventing or significantly reducing the formation of bubbles on the bulb 10. The bulb 10 itself may also be vibrated to reduce the formation of bubbles, by vibrating at least a portion of the conveyor system (e.g., the retaining means for the bulb or belt etc.) during the coating process. In the alternative, the bulb 10 may be vibrated alone or in combination with vibrating contents within dip tank 52. One benefit of using vibrations during the coating process is that is increases manufacturing efficiency. For example, the viscosity of the contents of the dip tank 52, may be between 7000-9000 cps prior to any vibrational energy being applied. When the bulb 10, dip tank 52, or both receive the vibrational energy, the viscosity may be reduced from 7000-9000 cps to approximately 100-1000 cps, thus allowing for a single dip in the drip tank mixture to achieve the desired coating thickness and desired level of containment. The vibrational energy may further be useful during other coating processes like spraying for example.

In an example, it is desired to achieve even and uniform application of the silicone coating in a desired thickness. To achieve a desired thickness, the viscosity of the silicone dispersion may be made to be in the range of 7000-9000 cps. The shape of the bulbs may be conducive to air being trapped and bubbles being formed, which is undesirable. The use of agitation or vibration tends to avoid the creation of bubbles, while allowing a desired thickness coating to be formed in a single dipping operation. The vibration effectively reduces the viscosity of the silicone dispersion thereby allowing for one dip in thick materials to achieve desired level of containment, while greatly increasing efficiency and high speed manufacturing. This allows the application of a thicker coating of silicone on the bulb after dipping, such as to a thickness of 0.50 mm or more on the glass surfaces and even thicker, such as 5.0 mm or more nearing connection to the tube above or base. The coating may be formed thicker around the base and also in between the spirals of glass making up the CFL.

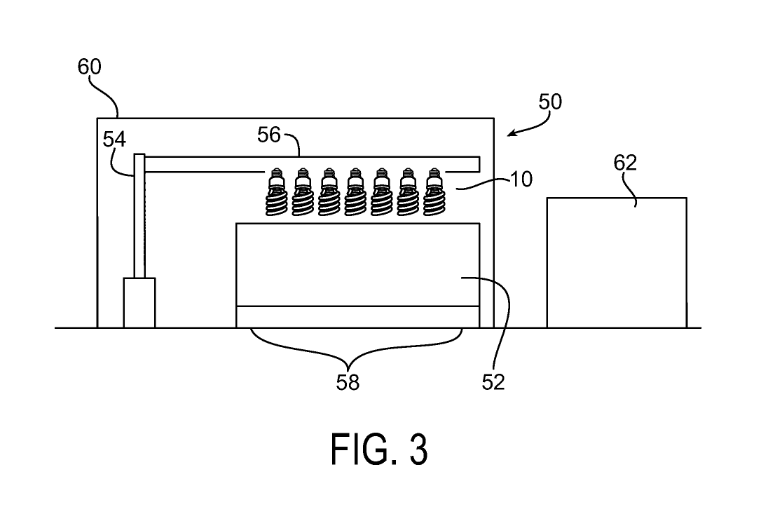

As shown in FIG. 3, the dipping system 50 may include a dip tank 52 and dipping fixture 54 is shown, with the dipping fixture 54 comprised of at least one work piece holding bar 56. The holding bar 56 may include holding one or more rows of bulbs 10 therewith, which each row selectively dipped into the dip tank 52, to increase throughput. The holding bar 56 may be selectively pivoted at a desired entrance/removal angle, and to flip the coated bulbs 10 after coating, by a suitable pivoting/rotating system. The vertical elevation of the holding bar 56 is controlled very accurately as it dips into the tank of coating solution.

The vertical elevation of the silicone dispersion is also known very accurately. As noted previously, a weir or level sensor keeps the level of the dispersion in the tank 52 constant. If desired, the tank 52 may also be supported on suitable vertical movers 58, such as motor driven screw jacks or the like, to raise or lower the tank 52. Alternately, the level of the dispersion in the tank 52 may be monitored and the amount of movement of the holding bar may be adjusted accordingly to dip the bulbs to the desired depth.

The proper dip level may be established by running a test dip of the bulb 10 and then examining that test piece. If the level of the dip tank needs to be adjusted the level can be accurately adjusted using the dispersion depth measurement and/or level of the dip tank 52. The level of dispersion in the tank 52 may remain constant, and once the proper level is set, the production pieces may be quickly and easily dipped into the dispersion. If discrepancies develop during a production run, the level of the dip tank 52 may be adjusted automatically or manually during the production run. The dip tank 52 may be enclosed in a hood assembly 60 to allow evacuation of any evaporated solvents, and to allow the application of a vacuum after coating for removal of any bubbles. After coating, the dipped bulbs 10 may be removed from the dip tank hood assembly and may be moved to and/or through a drying system 62, such as an oven, air circulation system or the like.

In another example, the system may allow for coating of bulbs 10 with a protective silicone rubber material by dipping the bulbs 10 into the silicone dispersion provided in a dip tank or by being sprayed, via a conveyor system for moving the bulbs through the coating machine. A fixture supporting a plurality of bulbs in an angled position relative to the surface of the silicone dispersion in said tank so that a predetermined area of each of the bulbs 10 is dipped into the protective silicone material as they are moved through the machine.

These methods of forming the coated bulbs 10 provides a seamless overmold on the bulb 10, that is adhered directly to the exterior surface of the bulbs 10, with a desired thickness. An automatic control system, well known in the art, may be used to control the rate of immersion and withdrawal as well as the period of submersion. The length of time of submersion and the number of submersions determines the thickness of the coating 12. The coating 12 on the bulbs may be air or oven dried after one or more submersions or after each submersion, assuring that the at least one solvent is evaporated. For example, drying by air drying may be for about one hour for one coat depending on thickness, with additional drying time if multiple coats are used. Using heat to facilitate drying, the coated bulbs 10 may be placed into 100° F. for about 25 minutes for example, depending on thickness. The temperature in which the coated bulbs may be dried may vary from about 100 to 200° F. for example, depending on the coating composition, solvents and solvent handling systems for example. Higher temperatures may be possible. The time may vary based upon the thickness of the coating, temperature or other factors.

Other methods of drying may be utilized. If desired, immediately upon withdrawal, after the final dispersion dip, the coated bulbs 10 may be exposed within a high vapor content chamber, such as a steam saturated atmosphere with an ambient temperature of less than 120° F., for about 30 seconds or until a fine, non-coalescing layer of condensate has been deposited over the surface of the uncured bulb coating. In an example, the uncured coated bulb is then allowed to dry for 15 to 30 minutes before curing at about 300° F. for approximately 25 minutes in a vented oven. This may form a gripable surface on the exterior of the coating 12 to facilitate use.

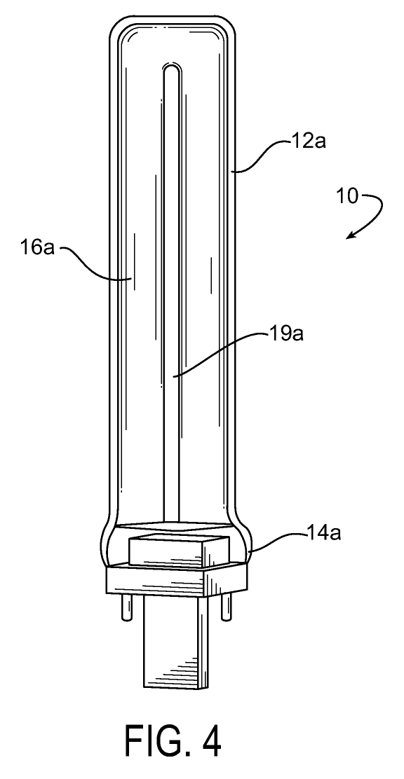

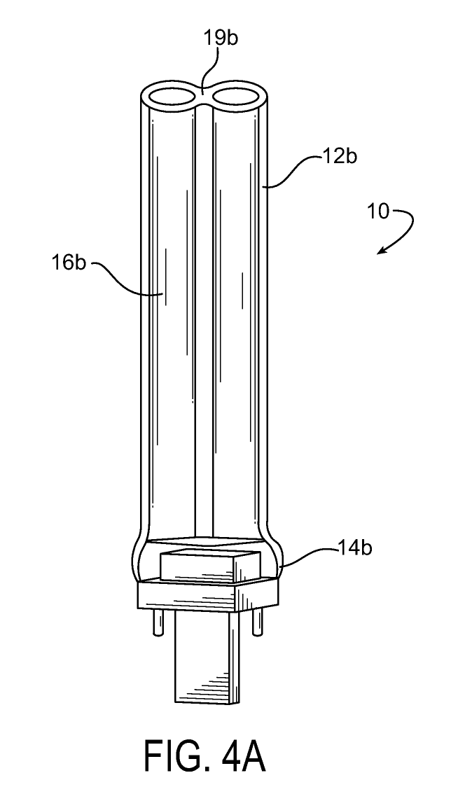

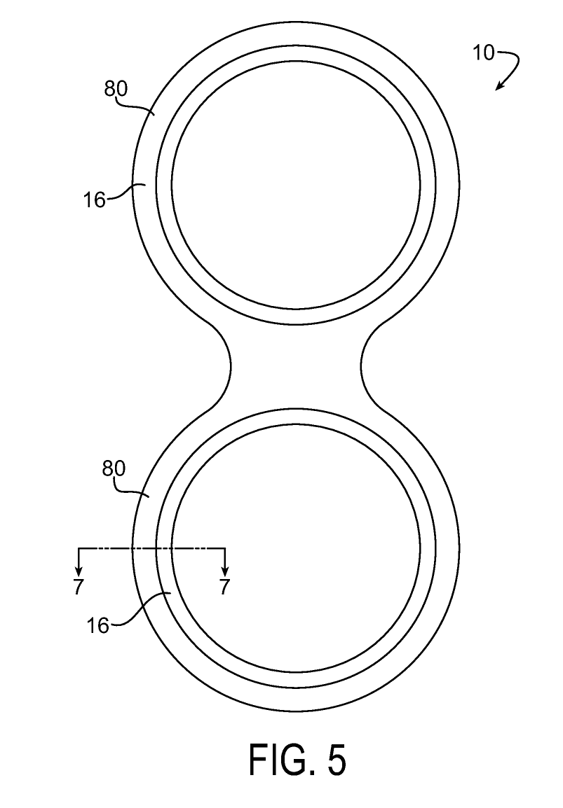

Alternate bulb configurations for a CFLs are shown in FIGS. 4 and 4A, and the features and characteristics of the coating 12 as described with reference to the example of FIG. 1 are maintained. In the configuration of CFLs 10a and 10b as shown in these Figs., the shatterproof silicone overmold 12a and 12b is shown. The coating 12a and 12b may be thick enough to provide advantages of impact resistance to make the bulbs 10a and 10b more shatterproof and for containment of glass, phosphorus and mercury if the bulb 10 or 10b breaks. The bulbs 10a and 10b have a gas filled tube 16a and 16b connected to the magnetic or electronic ballast contained in the base 18a and 18b. The coating 12a and 12b extends onto the plastic base 18a and 18b respectively, to an extent at 14a and 14b. The coating 12a and 12b may be thick enough to provide shock resistance to prevent breakage of the glass tube 16 in many typical drops, such as from a ladder, table, shelf or the like. The thickness may be between 0.3 mm to 2.5 mm for example, or for many CFL configurations, between about 0.5 to 1.5 mm, but other thicknesses may be suitable depending on the application or desired characteristics of the final product. For example, in some environments, it may be desired to have a thicker coating to provide enhanced protection against breakage or enhanced containment. It may also be desired to have a varying thickness coating on the bulb 10, for example with a thicker coating at the top or outer portions of the bulb 10, that are more likely to have impact forces exerted on them. The coating 12 provides shock resistance due to the nature of the coating itself, as well as the manner in which it contains the glass tube sections of the bulb 10a and 10b. As seen in FIGS. 4 and 4A, in these example embodiments, the bulb 10a and 10b is overmolded in such a fashion that the once independent or separated glass tubes 16a and 16b are now connected to each other via connecting sections or webs 19a and 19b of the coating 12a and 12b respectively. These connecting sections 19a and 19b again provide greatly increased structural strength of the bulb 10a and 10b and to each independent tube section 16a and 16b, to greatly increase the tensile strength of the bulbs and therefore reducing the risk of breakage. The connecting portions 19a and 19b also again allow for added performance and provide full containment with the entire coating 12a and 12b of any broken glass, phosphorus, mercury or other materials, and provide a reduced risk of breakage during installation and removal by counteracting a rotational force applied. The coating 12a and 12b further provide better gripping characteristics for installation and removal. As should be recognized, the coating of the bulb sections 16a and 16b may similarly be used with other possible configuration of compact fluorescent bulbs, with the coating easily applied to different size or shape fluorescent bulbs or articles.

In yet further embodiments, a system and methods for capturing or sequestering and/or stabilizing or neutralizing exposed mercury upon fracture or breakage of the bulb 10 is provided. The system and methods for stabilizing the mercury may include a stabilizing agent, which binds or chemically reacts with the exposed mercury of the bulb 10. The stabilizing agent may be any material capable of stabilizing mercury. In one embodiment the material is selenium. However, other materials capable of stabilizing mercury known to persons of ordinary skill in the art may be used. For example, copper, silver, sulfur, nickel and zinc are known to stabilize mercury. Additionally, activated carbon or other chemically modified activated carbon products may be used for stabilizing mercury.

The stabilizing agent may be a size small enough such that application to a bulb will not result in significant lumen loss. The stabilizing agent may be dispersed in a suitable medium, (e.g., the elastomeric silicone). The stabilizing agent may be provided in a powder form. In one embodiment, the stabilizing agent is a nanoparticle, for example, a nano-selenium. Additionally, individual or a mixture of nanoparticles of materials may be used in a suitable medium. With selenium and carbon, because these materials are typically not clear, it is beneficial to provide these materials in the smallest available form so that no significant lumen results.

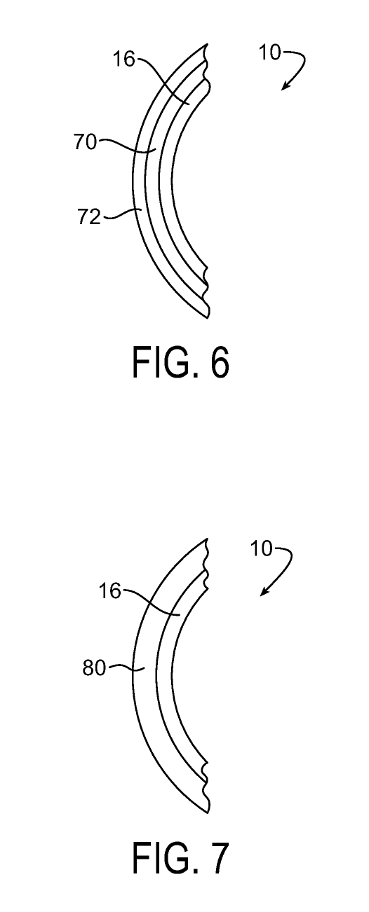

As illustrated in FIG. 6, the stabilizing agent may be applied to the outer layer of the bulb 10 in a manner to provide a first layer 70 for stabilizing the exposed mercury. This first layer 70 may then be coated with a second layer 72 of the silicone material previously discussed herein. In the alternative, the stabilizing agent may be applied to the bulb 10 as the outermost layer (i.e., applied after silicone layer). The thickness of the first layer 70 may be thicker or thinner than the thickness of the second layer 72 so long as the contents of the fluorescent bulb is contained. The coating of either layer may be formed by the dipping process or spraying process discussed herein, or by any other process known to a person of ordinary skill in the art. These processes may include vacuum deposition, where the stabilizing agent is vacuum deposited on the surface of the bulb 10. Alternately, spray deposition or incorporation of the stabilizing agent into a carrier solution, or deposition by pulsed-laser deposition, wherein a thin layer/film of the stabilizing agent is formed, at least in part from, the vaporizing of the materials may be suitable.

There are many contemplated mixtures to achieve desired neutralization or sequestration of the harmful elemental mercury. Selenium powder is available as 99 percent pure, odorless gray to black powder. Specifications include melting point of 217° C., density of 4.8, boiling point of 685° C. and a vapor pressure of 1 mm at 256° C. Selenium powder is chemically stable, and may be formed into nanoparticles in any suitable manner. In an example, the nano-selenium can also be integrated into the silicone dispersion to be coated onto the bulb concurrently. This approach may utilize encapsulation technology to allow introduction of the selenium, such as nano selenium (and/or other materials) before mixing with silicone or as a carrier medium. This may prevent any cross linking with or contamination by the silicone. In this embodiment, it is desired to leave the elemental nano selenium available to bond with the mercury in a suitable manner, such as by suspension of the nano selenium or other material in the silicone dispersion with all available bonding sites open to bind with mercury. For example, nano selenium can be dispersed in solvent (Heptane or a non voc solvent such as Dow oxygenated solvents) and the bulb is dipped, such that when solvent evaporates there will be a dry film left on the bulb glass as well as the top of the base. Alternatively, the other noted materials could be used other than or with selenium. The material could also be mixed with a very thin silicone and heptane mixture as a carrier instead of the solvent dispersion method. This will serve as a carrier for the neutralizing mixture to allow for greater concentration of neutralizing agent.

Other suitable carriers for the neutralizing agent could be used. The amount of stabilizing or neutralizing agent may also be selected to achieve desired neutralization of any mercury. For example, more than enough neutralizing agent could be used to ensure complete neutralization. For example, it may be desirable to have 10 or more milligrams of free nano selenium (or other material that will bind and neutralize) dispersed evenly across the entire surface area of glass and top of base after dipping.

Adding a selenium mixture to the silicone dispersion may further add to the structural integrity of the bulb 10. The amount of stabilizing or neutralizing agent may also be selected to achieve desired neutralization of any mercury. For example, more than enough neutralizing agent could be used to ensure complete neutralization. For example, it should take about 0.010 grams of nano selenium to neutralize 0.005 grams (typical amount in a CFL). Regular fluorescent light bulbs have 10-40 milligrams of mercury (0.01-0.04 grams of mercury), requiring more neutralizing agent in association therewith. Other ratios may be suitable, such as 0.5 mg of mercury may require 10 mg of nano-selenium to completely neutralize, but in an example for CFL's, there may be 10 or more milligrams of free nano selenium (or other material that will bind and neutralize) dispersed evenly across the entire surface area of glass and top of base after application.

In another example, providing a quarter to an equal amount of the stabilizing agent to mercury also proved effective in stabilizing exposed mercury, increasing the percent of the stabilizing agent to more than double the amount of mercury present is also effective. However, other percentage of the stabilizing agent to the mercury, capable of stabilizing exposed mercury, may be used.

The invention also contemplates incorporating a clear UV protection additive into the stabilizing agent or silicone dipping mixture to provide lighting that is safe for people who have medical conditions making them sensitive to ultraviolet light. Instead of keeping UV rays out. We will keep them in the bulb and restrict the flow of the UV spectrum only with the coating.

In another embodiment, the stabilizing agent is employed, the stabilizing agent may be dispersed or impregnated in the silicone elastomeric composition to form a single composition having both materials therein, further adding to the structural integrity of the bulb 10. In this embodiment, the stabilizing agent dispersion in the elastomeric composition may be substantially homogenous, such that effective amounts of the stabilizing agent may be evenly layered to stabilize and absorb any exposed mercury.

In these embodiments, the provision of the mercury stabilizing agent, such as selenide prevents the body from absorbing harmful mercury, thereby effectively sequestering or neutralizing the mercury. In the arrangement with the CFL, if breakage occurs, the immediate exposure to mercury, broken glass and contents of the fluorescent bulb is provided, such that the containment allows time for the selenium mixture to bind with the mercury to effectively neutralizing the harmful mercury. Should a fluorescent bulb (CFL or other fluorescent bulbs) according to the invention enter the landfill or the like, the bulb should no longer contain mercury, but instead will contain harmless mercury selenide. In the event mercury selenide enters the water supply, it is not readily absorbed by the body, and the harmful effects of the mercury are neutralized. In a further embodiment, a color forming agent may be use to produce a visual color change to the bulb when mercury selenide is formed to assure the user that the mercury has been neutralized. The invention also allows for traditional recycling efforts to reclaim any mercury left in bulb, if it arrives at a recycling center. Unlike mercury absorbent materials and packaging, the invention does not allow the mercury contents to become airborne and dangerous.

Although the invention has been shown and described in conjunction with examples thereof, the same are considered as illustrative and not restrictive, and that all changes and modifications that come within the spirit of the invention described by the following claims are within the scope thereof.

What is claimed is:

1. An coated compact fluorescent bulb comprising, at least one gas filled glass tube joined to a base containing a ballast, wherein the at least one gas filled glass tube includes an amount of mercury and phosphorus, and having at least one layer of silicone material having a predetermined thickness which substantially prevents the glass tube from shattering or breaking to thereby prevent the release of phosphorus and mercury if or when the bulb is dropped or other impact or force is imposed on the at least one glass tube, and wherein the at least one layer of silicone material provides for total glass and content containment within the silicone layer if the at least one glass tube does break.

2. The coated compact fluorescent bulb of claim 1, wherein the at least one layer of silicone provides for grip and structural reinforcement when installing and removing the bulb from a fixture.

3. The coated compact fluorescent bulb of claim 1, wherein the at least one layer of silicone is formed using liquid silicone materials.

4. The coated compact fluorescent bulb of claim 1, wherein the at least one glass filled tube includes at least two adjacent sections and the at least one layer of silicone includes a connecting portion that extends between the at least two adjacent sections that increases the tensile strength of the at least one glass tube by connecting the at least two adjacent sections of the at least one glass tube to one another.

5. The coated compact fluorescent bulb of claim 4, wherein the at least one glass tube is comprised of straight tube members with a longitudinal axis substantially parallel to the principal axis of the fluorescent lamp and the adjacent tube members being connected to each other in series to form a continuous arc path, and the tube members being arranged substantially at equal distance from the principal axis of the fluorescent lamp and from each other.

6. The coated compact fluorescent bulb of claim 4, wherein the glass tube arrangement is comprised of a single tube with substantially straight end sections and an intermediate portion between the end sections and the end sections being at one end of the tube arrangement and in proximity to each other and the intermediate portion having a coiled configuration wound about the principal axis of the lamp to provide the at least two sections.

7. The coated compact fluorescent bulb of claim 1, wherein the at least one layer of silicone is substantially void of color and crystal clear in appearance preventing decrease of lumen output from the bulb.

8. The coated compact fluorescent bulb of claim 1, wherein the at least one layer of silicone is chemically stable at the temperatures at which the bulb operates to allow the bulb to operate indefinitely without degradation of coating.

9. The coated compact fluorescent bulb of claim 1, where in the at least one layer of silicone provides a coating which bonds to the glass tube and the base forming a continuous layer over the connection therebetween that provides for containment of glass and the amounts of mercury and phosphorous in the event of breakage of the glass tube.

10. The coated compact fluorescent bulb of claim 1, wherein the at least one layer of silicone forms a coating which is substantially free of encapsulated bubbles.

11. The coated compact fluorescent bulb of claim 1, wherein the at least one layer of silicone forms a coating that provides for containment of glass and the amounts of mercury and phosphorous in the event of breakage of the glass tube and eliminates EPA recommended cleanup procedures in the event of breakage.

12. The coated compact fluorescent bulb of claim 1, wherein the at least one layer of silicone forms a coating that provides containment of glass and the amounts of mercury and phosphorous in the event of breakage of the glass tube to allow for safe transportation and storage to a recycling facility.

13. A method of manufacturing a coated fluorescent bulb comprising, a gas filled glass tube joined to a base containing a ballast wherein the gas filled glass tube includes an amount of mercury and phosphorus, comprising:
providing an apparatus for coating at least one fluorescent bulb with a protective material by dipping the bulbs into the protective material in a dip tank, including a fixture for holding the at least one fluorescent bulb,
formulating a silicone dispersion in the dip tank,
removing encapsulated bubbles from the dispersion,
recirculating and filtering the dispersion in the dip tank,
measuring the viscosity of the dispersion and maintaining a predetermined viscosity,
positioning at least one fluorescent bulb on the fixture,
dipping the at least one fluorescent bulb into the dispersion at a predetermined speed,
removing the at least one fluorescent bulb from the dispersion at a predetermined speed to form a coating on the fluorescent bulb,
flipping the at least one fluorescent bulb upon removal from the dispersion,
curing the coating on the at least one fluorescent bulb.

14. The method of claim 13, wherein the glass tube includes at least two adjacent sections and the coating increases the tensile strength in the coated glass tube by connecting the at least two sections of the glass tube to one another.

15. The method of claim 13, wherein the coating bonds to the glass tube and the base, forming a continuous layer over the connection therebetween that provides for containment of glass and the amounts of mercury and phosphorous in the event of breakage of the glass tube.

16. A coated compact fluorescent bulb comprising:
at least one gas filled glass tube joined to a base containing a ballast, wherein the at least one gas filled glass tube includes contents having mercury and phosphorus,
at least one layer applied to a surface of the at least one glass tube, wherein the at least one layer has a predetermined thickness, and wherein the at least one layer provides for containing the contents if the at least one glass tube fractures.

17. The compact fluorescent bulb of claim 16, wherein the at least one layer comprises a silicon material for preventing the release of phosphorus and mercury.

18. The compact fluorescent bulb of claim 17, wherein the at least one layer further comprises a means for stabilizing the mercury.

19. The compact fluorescent bulb of claim 18, wherein the means for stabilizing the mercury is a stabilizing agent selected from the group consisting of selenium, activated carbon, sulfur, silver, copper, nickel and zinc.

20. The compact fluorescent bulb of claim 19, wherein stabilizing agent is selenium, and wherein the selenium is a nanoparticle.
